(19) United States
(12) Patent Application Publication
(10) Pub. No.: US 2019/0129743 A1
(43) Pub. Date: May 2, 2019

(54) METHOD AND APPARATUS FOR MANAGING VIRTUAL MACHINE

(71) Applicant: EMC IP Holding Company LLC, Hopkinton, MA (US)

(72) Inventors: Qingxiao Zheng, Chengdu (CN); Derro Xu, Chengdu (CN); Ophone Ou, Chengdu (CN)

(21) Appl. No.: 16/169,296

(22) Filed: Oct. 24, 2018

(30) Foreign Application Priority Data
Oct. 27, 2017 (CN) CN 201711025420.5

(51) Int. Cl. G06F 9/455; G06F 9/50; G06F 9/46; G06F 17/30

(52) U.S. Cl. CPC G06F 9/45558; G06F 9/5077; G06F 17/30238; G06F 17/30091; G06F 9/468

(57) ABSTRACT

Embodiments of the present disclosure relate to a method and device for managing a virtual machine. The method comprises: in response to determining that a target virtual machine is unavailable, determining a target storage device associated with the target virtual machine; creating, based on information of a partition of the target storage device, a loop device for the partition; associating the loop device for the partition with a partition access path; and accessing a file system of the partition through the partition access path.

### RELATED APPLICATIONS

This application claim priority from Chinese Patent Application Number CN 201711025420.5, filed on Oct. 27, 2017 at the State Intellectual Property Office, China, titled “METHOD, APPARATUS, AND COMPUTER PROGRAM PRODUCT FOR MANAGING VIRTUAL MACHINE” the contents of which is herein incorporated by reference in its entirety.

### FIELD

Embodiments of the present disclosure generally relate to virtual machine management, and more specifically, to a method and device for managing a virtual machine.

### BACKGROUND

Currently, there are two ways to restore data of a virtual machine: image restore and file level restore. In the image restore, the entire image backup of the virtual machine is restored. Compared with the image restore, the file level restore is more flexible. In particular, in the file level restore, a particular file or folder of the virtual machine can be restored, and it is not necessary to extract an image backup of the source virtual machine for restoring the data of the virtual machine to a temporary location or to start the source virtual machine before the restore. In this manner, the file and folder may be restored to a specific time point from a regular image backup.

However, in the event that the virtual machine is not available, for example, when the virtual machine fails or shuts down, such file level restore cannot be performed normally. Therefore, an improved solution is needed to improve data restore performance.

### SUMMARY

Embodiments of the present disclosure provide a method and device for managing a virtual machine.

In a first aspect of the present disclosure, there is provided a method of managing a virtual machine, comprising: in response to determining that a target virtual machine is unavailable, determining a target storage device associated with the target virtual machine; creating, based on information of a partition of the target storage device, a loop device for the partition; associating the loop device for the partition with a partition access path; and accessing a file system of the partition through the partition access path.

In a second aspect of the present disclosure, there is provided a device for managing a virtual machine. The device comprises: at least one processing unit and at least one memory. The at least one memory is coupled to the at least one processing unit and stores instructions to be executed by the at least one processing unit. The instructions, when executed by the at least one processing unit, cause the device to perform acts: in response to determining that a target virtual machine is unavailable, determining a target storage device associated with the target virtual machine; creating, based on information of a partition of the target storage device, a loop device for the partition; associating the loop device for the partition with a partition access path; and accessing a file system of the partition through the partition access path.

In a third aspect of the present disclosure, there is provided a computer program product that is tangibly stored on a non-transitory computer readable medium and includes machine-executable instructions. The machine-executable instructions, when executed, cause a machine to perform steps of the method described according to the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent. In example embodiments of the present disclosure, the same reference signs usually represent the same components.

FIG. 1 is a schematic diagram illustrating a virtual machine management system in accordance with embodiments of the present disclosure;

FIG. 2 is a flowchart illustrating a method of managing a virtual machine in accordance with embodiments of the present disclosure; and

FIG. 3 is a schematic block diagram illustrating an example device that can be used to implement embodiments of the present disclosure.

Throughout the drawings, the same or corresponding reference signs refer to the same or corresponding parts.

### DETAILED DESCRIPTION OF EMBODIMENTS

Preferred embodiments of the present disclosure will be described in the following in greater detail with reference to the drawings. Although the preferred embodiments of the present disclosure are displayed in the drawings, it is to be understood that the present disclosure may be implemented in various manners, and should not be limited to the embodiments illustrated herein. On the contrary, these embodiments are provided to make the present disclosure more thorough and complete and fully convey the scope of the present disclosure to those skilled in the art.

As used herein, the term “include” and its variants are to be read as open-ended terms that mean “include, but is not limited to.” The term “or” is to be read as “and/or” unless the context clearly indicates otherwise. The term “based on” is to be read as “based at least in part on.” The terms “an example embodiment” and “an embodiment” are to be read as “at least one example embodiment.” The term “another embodiment” is to be read as “at least one further embodiment.” The terms “first” and “second” can represent different or same objects. The following text may also include other explicit and implicit definitions. For the ease of description, in embodiments of the present disclosure, the virtual machine whose data is to be restored is referred to as a target virtual machine, and the virtual machine for restoring the data of the target virtual machine is referred to as a source virtual machine.

Conventionally, in the file level restore, to restore files of the target virtual machine, the target virtual machine must be installed and run an application for restoring the files of the target virtual machine. Generally, this application may be implemented in two manners: active (“pull”) and passive (“push”).

On the one hand, when the active restore application is used, the target virtual machine runs the active restore application to obtain files of the source virtual machine so as to restore the files of the target virtual machine. For example, the active restore application may download the files of the source virtual machine using network protocols such as HTTP, HTTPS and FTP to restore the files of the target virtual machine. On the other hand, when the passive restore application is used, the target virtual machine runs the passive restore application to receive the files of the source virtual machine that are uploaded to the target virtual machine, so as to restore the files of the target virtual machine.

In the above two conditions, as the target virtual machine needs to run the application for restoring the files of the target virtual machine, there is a limit to the state of the target virtual machine. In particular, when the file level restore is utilized to restore the particular file, the target virtual machine must be in an available state.

Due to such limitation, when the end user hopes to restore files to a closed target virtual machine, the target virtual machine needs to be opened before the restore. Compared with the time for restore, it might take a longer time to open the target virtual machine. For example, the time for restore may be only several seconds, while the time for opening the virtual machine may be several minutes. Moreover, the target virtual machine cannot be opened in the event of failure. In this case, the above restore process cannot be accomplished. All these situations will lead to degradation in user experience.

To at least partially solve one or more of the above problems and other potential problems, example embodiments of the present disclosure propose a solution for managing a virtual machine. By associating the virtual machine management device and the storage device of an unavailable target virtual machine, the solution enables the virtual machine management device to operate the storage device of the unavailable virtual machine directly. In this manner, it is possible to operate the unavailable target virtual machine without waiting for the target virtual machine to become available to restore the data of the target virtual machine. Thus, the availability and performance of the virtual machine management system can be improved in a concise and efficient way so as to enhance user experience.

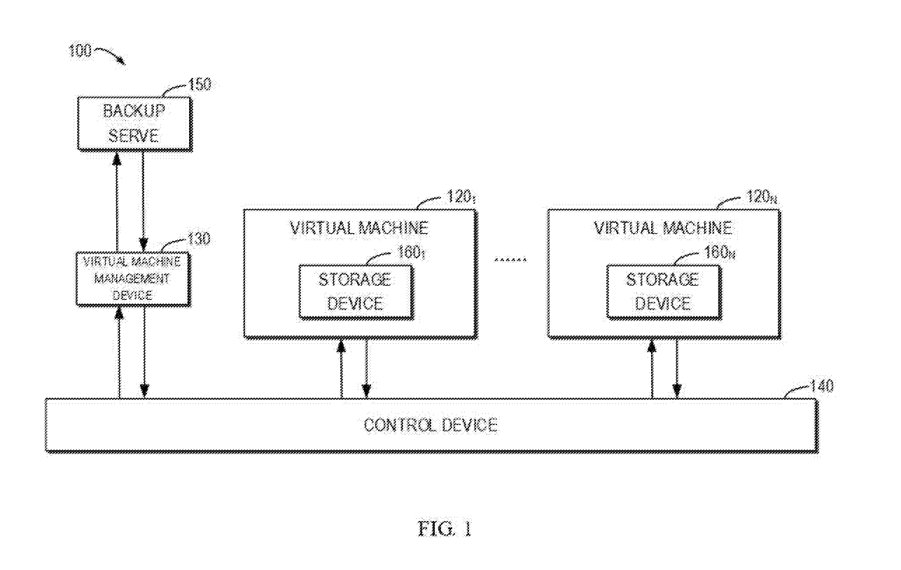

FIG. 1 is a schematic diagram illustrating a virtual machine management system 100 in accordance with embodiments of the present disclosure. It shall be appreciated that the virtual machine management system 100 shown in FIG. 1 is only for illustrative purpose, without suggesting any limitation to the scope of the present disclosure. Embodiments of the present disclosure may be embodied in different structures.

As illustrated in FIG. 1, the virtual machine management system 100 includes a group of virtual machines 120₁-120_{N} (hereinafter collectively referred to as virtual machine 120), where N is a natural number greater than 1. The virtual machines 120₁-120_{N} include storage devices 160₁-160_{N} (hereinafter collectively referred to as storage device 160) for storing data of the virtual machine. The storage device 160 may be a tangible physical storage device (such as a physical disk) or an intangible storage device (such as a disk file).

The virtual machine management system 100 further includes a virtual machine management device 130 for managing the group of virtual machines 120. For example, the virtual machine management device 130 may support the restore of the virtual machine 120. Thus, the virtual machine management system 100 operates the virtual machine 120 through the virtual machine management device 130 without managing the virtual machine 120 directly. According to embodiments of the present disclosure, the virtual machine management device 130 may be implemented in various manners. In some embodiments, the virtual machine management device 130 may be implemented as a proxy for managing the virtual machine 120. For the sake of clarity, FIG. 1 only illustrates one virtual machine management device 130 managing a group of virtual machines 120. However, it is to be understood that there may be a plurality of virtual machine management devices 130 managing multiple or multiple groups of virtual machines 120, respectively.

The virtual machine management system 100 further includes a control device 140 for controlling the virtual machine. In some embodiments, the virtual machine management device 130 operates the virtual machine by accessing the control device 140. For example, the control device 140 may provide a group of application programming interfaces. The virtual machine management device 130 may access these application programming interfaces to request for operating the virtual machine. Then, the control device 140 returns the result of operating the virtual machine to the virtual machine management device 130.

In addition, the virtual machine management system 100 may further include a backup server 150 for storing the backup of the virtual machine 120. In some embodiments, for example, the backup operation is performed on the virtual machine periodically or at a specified time, and the backup of the virtual machine is stored in the backup server 150 for restoring the virtual machine subsequently.

The virtual machine management device 130 may be associated with one or more storage devices 160. In some embodiments, the available path of the virtual machine management device 130 may be associated with one or more storage devices 160. For example, the storage device 160 may be mounted to this available path.

When the virtual machine management device 130 needs to access the storage device 160 (hereinafter referred to as target storage device 160) associated with the virtual machine 120 (hereinafter referred to as target virtual machine 120), the virtual machine management device 130 may first determine the availability of the target virtual machine 120. Here, the target virtual machine may be one or more virtual machines among the virtual machines 120₁-120_{N} to be operated by the virtual machine management device 130.

The target virtual machine 120 may be unavailable for various reasons, for instance, the virtual machine being in the closed state, some files in the virtual machine being damaged, the virtual machine being failed and so on. When it is determined that the target virtual machine 120 is unavailable, the virtual machine management device 130 may determine the target storage device 160 associated with the target virtual machine 120.

In some embodiments, the virtual machine management device 130 may transmit a storage device determination request associated with the target virtual machine 120 to the control device 140, and receive a storage device determination response from the control device 140, so as to obtain the device access path for accessing the target storage device. Alternatively, the virtual machine management device 130 itself may determine the target storage device 160.

In some embodiments, the control device 140 may provide a group of application programming interfaces. In this case, the virtual machine management device 130 may access these application programming interfaces to transmit the storage device determination request to the control device 140. In some embodiments, the storage device determination request, for instance, may be a request for mounting the target storage device 160 to the virtual machine management device 130. In some embodiments, the storage device determination response may include a device access path for accessing the target storage device 160. For example, the device access path may be a path of the target storage device 160 on the virtual machine management device 130. Alternatively, the device access path may be any path of the target storage device 160 accessible to the virtual machine management device 130.

In some embodiments, the storage device determination response may only include information associated with the target storage device 160. For example, the device access path for accessing the target storage device 160 contained in the storage device determination response may be a path of a flat file removed of header information associated with the virtual machine management system 100. The flat file is a file containing records that do not have a relative relationship structure, such as a plain text file. Alternatively, in addition to information associated with the target storage device 160, the storage device determination response may further contain information associated with the virtual machine management system 100. In this case, the virtual machine management device 130 may analyze and remove the information associated with virtual machine management system 100.

Furthermore, the virtual machine management device 130 creates, based on information of a partition of the target storage device 160, a loop device for the partition, so that the partition is associated with the virtual machine management device 130. The loop device is not a physical device, but a virtual one. The loop device maps files existing in the file system into a virtual block device, so that the virtual machine management device 130 can access the files in a manner of accessing the block device. The block device is an input/output device which stores data in blocks of a fixed size, each block having its respective address, and supports accessing data in the unit of block.

In some embodiments, to create a loop device for the partition of the target storage device 160, the virtual machine management device 130 creates a loop device for the target storage device 160 so that the target storage device 160 is associated with the virtual machine management device 130. In this manner, the virtual machine management device 130 may obtain information of the partition of the target storage device 160 based on the created loop device for the target storage device 160. In some embodiments, the virtual machine management device 130 may analyze the loop device for the target storage device 160 with, for instance, a disk analyzing tool, to obtain the information of the partition of the target storage device 160. In some embodiments, the information of the partition may include the format of the file system of the target storage device 160 (such as NTFS or FAT), the start address of the partition on the target storage device 160 and/or other relevant information. For example, the information of the partition may be a Master Boot Record (MBR), Globally Unique Identifier Partition Table (GUID Partition Table, GPT) and so on.

As stated above, when the information of the partition indicates the start address of the partition on the target storage device 160, the virtual machine management device 130 may obtain the start address from the information of the partition, and associate the loop device for the partition with the start address. For example, the virtual machine management device 130 may create a loop device for the partition from the start address. Generally, the target storage device 160 includes at least one partition. In the case where the target storage device 160 includes a plurality of partitions, the virtual machine management device 130 may create a respective loop device for each of a plurality of partitions from the start address of each of the plurality of partitions.

Furthermore, the virtual machine management device 130 associates the loop device for the partition with the partition access path. In some embodiments, the virtual machine management device 130 determines the partition access path from available paths of the virtual machine management device 130, and mounts the loop device for the partition to the partition access path. For example, the partition access path may be a local path on the virtual machine management device 130. Alternatively, the partition access path may also be a remote path for the virtual machine management device 130.

In this manner, as the file system of the target storage device 160 exists on the partition, the virtual machine management device 130 may access the file system through the partition access path. As stated above, in the condition that the partition access path is a local path on the virtual machine management device 130, since the loop device for the partition is associated with the local partition access path on the virtual machine management device 130, the virtual machine management device 130 may operate the file system of the target storage device 160, in a similar manner of operating the file system of the local storage device.

The virtual machine management device 130 may access the file system in various manners. In some embodiments, the virtual machine management device 130 may read files in the file system. Additionally or alternatively, the virtual machine management device 130 may perform a write operation to the files in the file system. Additionally or alternatively, the virtual machine management device 130 may restore the files in the file system.

When the files in the file system of the target virtual machine 120 are restored, the virtual machine management device 130 determines a source virtual machine for restoring the target virtual machine 120, and further determines the source storage device associated with the source virtual machine. In some embodiments, the source storage device may be an image backup of the source virtual machine on the backup server 150. Alternatively, the source storage device may be a currently active storage device of the source virtual machine, for instance, a currently active disk file. In some embodiments, for the virtual machine management device 130, the source storage device is in a read-only state, thereby ensuring data security.

To restore the files in the file system of the target virtual machine 120, the virtual machine management device 130 further associates the source storage device with an available path of the virtual machine management device 130. For example, the available path may be a local path on the virtual machine management device 130. Alternatively, the available path may also be a remote path to the virtual machine management device 130. In some embodiments, the virtual machine management device 130 mounts the determined source storage device to the available path of the virtual machine management device 130. For example, the virtual machine management device 130 may request the backup server 150 to mount the determined source storage device to the available path of the virtual machine management device 130. In this manner, the virtual machine management device 130 may restore the files in the file system of the target virtual machine 120 by accessing the source storage device through this available path.

Through the above description, embodiments of the present disclosure enable the virtual machine management device 130 to operate the target storage device 160 directly by associating the virtual machine management device 130 with the target storage device 160 of the unavailable target virtual machine 120. In this manner, on the one hand, the defect that the virtual machine management device 130 cannot operate the unavailable target virtual machine 120 and needs to wait for the target virtual machine 120 to become available is eliminated; on the other hand, compared with the manner of using active restore application and passive restore application, as the virtual machine management device 130 operates the target storage device 160 directly, the efficiency and convenience of the operation is significantly improved. Therefore, the solution for managing the virtual machine disclosed herein improves the availability and performance of the virtual machine management system 100 in a concise and efficient manner.

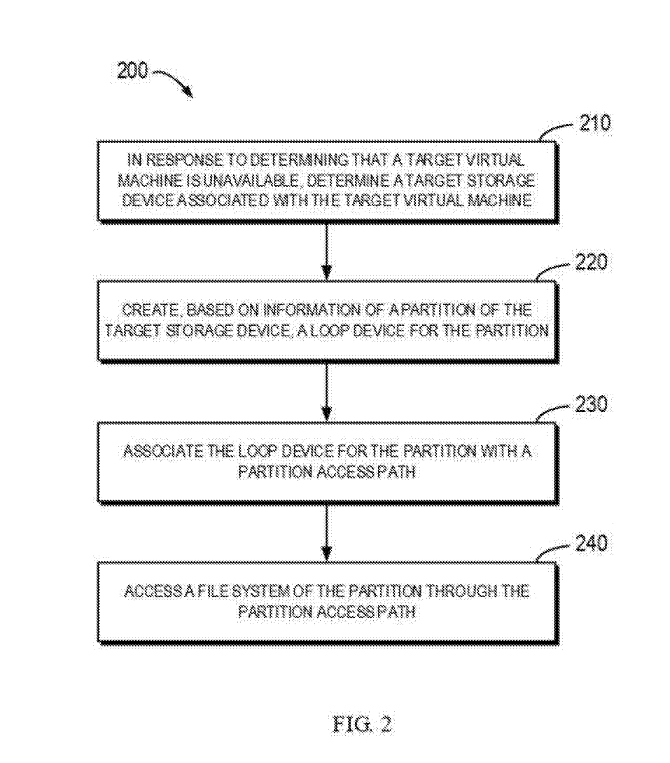

FIG. 2 is a flowchart illustrating a method 200 of managing a virtual machine in accordance with embodiments of the present disclosure. For example, the method 200 may be implemented by the virtual machine management device 130 shown in FIG. 1. It is to be understood that method 200 may further include additional steps not shown and/or omit the shown steps, and the scope of the present disclosure is not limited in this regard.

At 210, when determining that the target virtual machine 120 is unavailable, the virtual machine management device 130 determines the target storage device 160 associated with the target virtual machine 120. In some embodiments, to determine the target storage device 160 associated with the target virtual machine 120, the virtual machine management device 130 may transmit a storage device determination request associated with the target virtual machine 120 to the control device 140. When the storage device determination request is received, the control device 140 may transmit a storage device determination response to the virtual machine management device 130, the storage device determination response including a device access path for accessing the target storage device 160. In this manner, the virtual machine management device 130 may determine the target storage device 160 associated with the target virtual machine 120 based on the storage device determination response.

At 220, the virtual machine management device 130 creates, based on information of a partition of the target storage device 160, a loop device for the partition. In some embodiments, to create a loop device for the partition, the virtual machine management device 130 may create a loop device for the target storage device 160. The virtual machine management device 130 may obtain the information of the partition based on the loop device for the target storage device 160, and create the loop device for the partition based on the information of the partition. In some embodiments, in particular, the virtual machine management device 130 may obtain the start address of the partition on the target storage device 160 from the information of the partition, and associate the loop device for the partition with the start address to create the loop device for the partition.

At 230, the virtual machine management device 130 associates the loop device for the partition with the partition access path. In some embodiments, to associate the loop device for the partition with the partition access path, the virtual machine management device 130 determines the partition access path from its available paths and mounts the loop device for the partition to the partition access path.

At 240, the virtual machine management device 130 accesses the file system of the partition through the partition access path. As stated above, the virtual machine management device 130 may access the file system in various manners. In some embodiments, the virtual machine management device 130 may read files in the file system. Additionally or alternatively, the virtual machine management device 130 may perform a write operation to the files in the file system. Additionally or alternatively, the virtual machine management device 130 may restore the files in the file system. In the case of restoring the files in the file system of the target virtual machine 120, the virtual machine management device 130 determines the source virtual machine for restoring the target virtual machine 120, and further determines the source storage device associated with the source virtual machine. To restore the files in the file system of the target virtual machine 120, the virtual machine management device 130 further associates the determined source storage device with the available path of the virtual machine management device 130, and accesses the source storage device through the available path to restore the files in the file system.

Through the above description, embodiments of the present disclosure enable the virtual machine management device 130 to operate the target storage device 160 directly by associating the virtual machine management device 130 with the target storage device 160 of the unavailable target virtual machine 120. In this manner, even if the target virtual machine 120 is unavailable, the virtual machine management device 130 may also operate the target virtual machine 120, and does not need to wait for the target virtual machine 120 to become available. Thus, such direct operation improves the efficiency and convenience of the operation significantly.

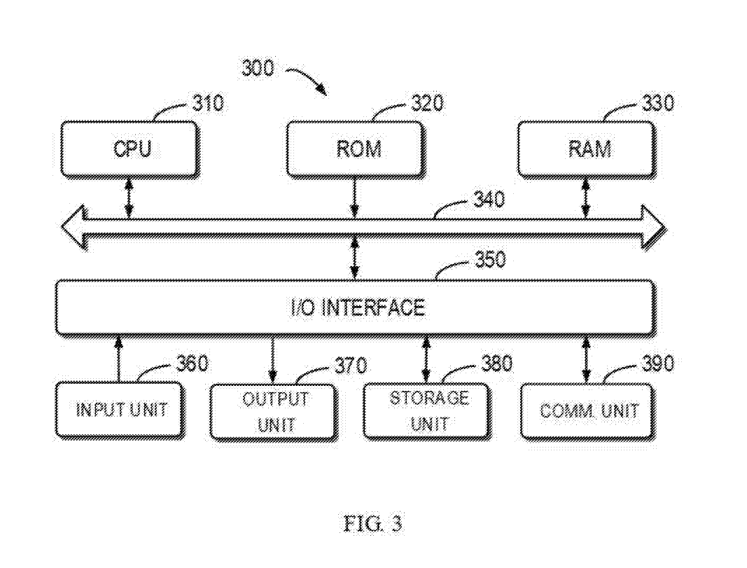

FIG. 3 illustrates a schematic diagram of an example device 300 for implementing embodiments of the present disclosure. For example, the virtual machine management device 130 shown in FIG. 1 can be implemented by the device 300. As shown, the device 300 includes a central processing unit (CPU) 310, which can perform various appropriate acts and processing based on the computer program instructions stored in a read-only memory (ROM) 320 or the computer program instructions loaded into a random-access memory (RAM) 330 from a storage unit 380. The RAM 330 can also store various programs and data required for the operation of the device 300. The CPU 310, the ROM 320 and the RAM 330 are connected to each other via a bus 340. An input/output (I/O) interface 350 is also connected to the bus 340.

A plurality of components in the device 300 are connected to the I/O interface 350, including: an input unit 360, such as a keyboard, a mouse and the like; an output unit 370, such as various kinds of displays and loudspeakers and the like; the storage unit 380, such as a magnetic disk and an optical disk and the like; and a communication unit 390, such as a network card, a modem, a wireless transceiver and the like. The communication unit 390 allows the device 300 to exchange information/data with other devices via the computer network, such as the Internet, and/or various telecommunication networks.

The above described procedures and processing, such as the method 200, can also be performed by the processing unit 310. For example, in some embodiments, the method 200 can be implemented as a computer software program tangibly included in the machine-readable medium, for example, the storage unit 380. In some embodiments, the computer program can be partially or fully loaded and/or mounted to the device 300 via the ROM 320 and/or the communication unit 390. When the computer program is loaded onto RAM 330 and executed by the CPU 310, one or more acts of the above described method 200 can be implemented.

The present disclosure can be a method, apparatus, system and/or computer program product. The computer program product can include a computer readable storage medium, on which the computer readable program instructions for performing various aspects of the present disclosure are loaded.

The computer readable storage medium can be a tangible device that maintains and stores instructions utilized by the instruction executing device. For example, the computer readable storage medium can be, but not limited to, an electrical storage device, a magnetic storage device, an optical storage device, an electromagnetic storage device, a semiconductor storage device or any appropriate combinations of the above. More detailed examples (non-exhaustive list) of the computer readable storage medium include: a portable computer disk, a hard disk, a random-access memory (RAM), a read-only memory (ROM), an erasable programmable read-only memory (EPROM or flash memory), a static random-access memory (SRAM), a portable compact disk read-only memory (CD-ROM), a digital versatile disk (DVD), a memory stick, a floppy disk, a mechanical coding device, a punched card having stored instructions thereon, or raised structures in a groove, and any appropriate combinations of the above. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical fibers transmission, wireless transmission, routers, firewalls, switches, gateway computers and/or edge servers. A network adapter card or network interface in each computing/processing device receives computer readable program instructions from the network, and forwards the computer readable program instructions for storing in a computer readable storage medium within the respective computing/processing device.

Computer program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the case relating to the remote computer, the remote computer may be connected to the user's computer through any type of network, including a local area network (LAN) or a wide area network (WAN), or may be connected to an external computer (for example, through the Internet using an Internet Service Provider). In some embodiments, electronic circuitry, for example, programmable logic circuitry, field-programmable gate arrays (FPGA), or programmable logic arrays (PLA), which may execute computer readable program instructions, may be customized by utilizing the state information of the computer readable program instructions, in order to perform aspects of the present disclosure.

Aspects of the present disclosure are described herein with reference to flowchart illustrations and/or block diagrams of methods, apparatus (systems), and computer program products according to embodiments of the disclosure. It would be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, being executed by the processing unit of the computer or other programmable data processing apparatus, create an apparatus for implementing the functions/acts specified in the flowchart and/or block diagram block or blocks. These computer readable program instructions may also be stored in a computer readable storage medium, and direct a computer, a programmable data processing apparatus, and/or other devices to function in a particular manner, such that the computer readable storage medium having instructions stored therein comprises an article of manufacture including instructions which implement aspects of the functions/acts specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions, being executed on the computer, other programmable apparatus, or other device, implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, code segment, or portion of code, which comprises one or more executable instructions for implementing the specified logical function(s). In some alternative implementations, the functions noted in the block may occur in an order different from that noted in the figures. For example, two blocks shown in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for the purpose of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or the technical improvement over technologies found in the marketplace, or to enable others of ordinary skilled in the art to understand the embodiments disclosed herein.

I/We claim:

1. A method of managing a virtual machine, comprising:
in response to determining that a target virtual machine is unavailable, determining a target storage device associated with the target virtual machine;
creating, based on information of a partition of the target storage device, a loop device for the partition;
associating the loop device for the partition with a partition access path; and
accessing a file system of the partition through the partition access path.

2. The method according to claim 1, wherein determining the target storage device associated with the target virtual machine comprises:
transmitting a storage device determination request associated with the target virtual machine to a control device; and
receiving a storage device determination response from the control device, the storage device determination response including a device access path for accessing the target storage device.

3. The method according to claim 1, wherein creating the loop device for the partition comprises:
creating a loop device for the target storage device;
obtaining the information of the partition based on the loop device for the target storage device; and
creating the loop device for the partition based on the information of the partition.

4. The method according to claim 1, wherein creating the loop device for the partition comprises:
obtaining, from the information of the partition, a start address of the partition on the target storage device; and
associating the loop device for the partition with the start address.

5. The method according to claim 1, wherein associating the loop device for the partition with the partition access path comprises:
determining the partition access path from available paths of a virtual machine management device; and
mounting the loop device for the partition to the partition access path.

6. The method according to claim 1, wherein accessing the file system of the partition through the partition access path comprises:
reading a file in the file system;
performing a write operation to the file in the file system; and
restoring the file in the file system.

7. The method according to claim 6, wherein restoring the file in the file system comprises:
determining a source virtual machine for restoring the target virtual machine;
determining a source storage device associated with the source virtual machine;
associating the source storage device with an available path of the virtual machine management device; and
accessing the source storage device through the available path to restore the file in the file system.

8. A device for managing a virtual machine, comprising:
at least one processing unit;
at least one memory, the at least one memory being coupled to the at least one processing unit and storing instructions to be executed by the at least one processing unit, the instructions, when executed by the at least one processing unit, causing the device to perform acts comprising:
in response to determining that a target virtual machine is unavailable, determining a target storage device associated with the target virtual machine;
creating, based on information of a partition of the target storage device, a loop device for the partition;
associating the loop device for the partition with a partition access path; and
accessing a file system of the partition through the partition access path.

9. The device according to claim 8, wherein determining the target storage device associated with the target virtual machine comprises:
transmitting a storage device determination request associated with the target virtual machine to a control device; and
receiving a storage device determination response from the control device, the storage device determination response including a device access path for accessing the target storage device.

10. The device according to claim 8, wherein creating the loop device for the partition comprises:
creating a loop device for the target storage device;
obtaining the information of the partition based on the loop device for the target storage device; and
creating the loop device for the partition based on the information of the partition.

11. The device according to claim 8, wherein creating the loop device for the partition comprises:
obtaining, from the information of the partition, a start address of the partition on the target storage device; and
associating the loop device for the partition with the start address.

12. The device according to claim 8, wherein associating the loop device for the partition with the partition access path comprises:
determining the partition access path from available paths of a virtual machine management device; and
mounting the loop device for the partition to the partition access path.

13. The device according to claim 8, wherein accessing the file system of the partition through the partition access path comprises:
reading a file in the file system;
performing a write operation to the file in the file system; and
restoring the file in the file system.

14. The device according to claim 10, wherein restoring the file in the file system comprises:
determining a source virtual machine for restoring the target virtual machine;
determining a source storage device associated with the source virtual machine;
associating the source storage device with an available path of the virtual machine management device; and
accessing the source storage device through the available path to restore the file in the file system.

15. A computer program product for managing a virtual machine, the computer program product comprising:
a non-transitory computer readable medium encoded with computer-executable program code, the code configured to enable the execution of:
in response to determining that a target virtual machine is unavailable, determining a target storage device associated with the target virtual machine;
creating, based on information of a partition of the target storage device, a loop device for the partition;
associating the loop device for the partition with a partition access path; and
accessing a file system of the partition through the partition access path.

16. The computer program product of claim 15, wherein determining the target storage device associated with the target virtual machine comprises:
transmitting a storage device determination request associated with the target virtual machine to a control device; and
receiving a storage device determination response from the control device, the storage device determination response including a device access path for accessing the target storage device.

17. The computer program product of claim 15, wherein creating the loop device for the partition comprises:
creating a loop device for the target storage device;
obtaining the information of the partition based on the loop device for the target storage device; and
creating the loop device for the partition based on the information of the partition.

18. The computer program product of claim 15, wherein creating the loop device for the partition comprises:
obtaining, from the information of the partition, a start address of the partition on the target storage device; and
associating the loop device for the partition with the start address.

19. The computer program product of claim 15, wherein associating the loop device for the partition with the partition access path comprises:
determining the partition access path from available paths of a virtual machine management device; and
mounting the loop device for the partition to the partition access path.
The computer program product of claim 15, wherein accessing the file system of the partition through the partition access path comprises:
reading a file in the file system;
performing a write operation to the file in the file system; and
restoring the file in the file system.
